(19) United States
(12) Patent Application Publication
(10) Pub. No.: US 2017/0288526 A1
(43) Pub. Date: Oct. 5, 2017

(54) SELF-GENERATING POWER GENERATION SYSTEM

(71) Applicant: Omar Alheraiqi, Altoona, PA (US)

(72) Inventor: Omar Alheraiqi, Altoona, PA (US)

(21) Appl. No.: 15/474,906

(22) Filed: Mar. 30, 2017

Related U.S. Application Data
(60) Provisional application No. 62/315,558, filed on Mar. 30, 2016.

(51) Int. Cl. H02K 47/14; H02K 7/116; H02K 11/33; B60L 11/18

(52) U.S. Cl. CPC H02K 47/14; B60L 11/1805; B60L 11/1864; B60L 11/1861; H02K 7/116; H02K 11/33; B60L 11/1809; B60K 2001/0411

(57) ABSTRACT

A self-generating power generation system is a generating system that is designed to use a portion of the incoming power to generate additional power to make the system highly efficient. The system may be used in a motor vehicle and take advantage of the available kinetic energy of the turning wheels regenerate power to multiply the efficiency. The system uses two batteries, a brushless dc motor, a generator, gearing, relays, switches, a regulator, a diode, and a controller.

### CROSS-REFERENCE TO RELATED APPLICATION

The present application is related to and claims priority from prior provisional application Ser. No. 62/315,558, filed Mar. 30, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of power generating systems and more specifically relates to self-generating power generation system.

### 2. DESCRIPTION OF THE RELATED ART

In physics, energy is a property of objects which can be transferred to other objects or converted into different forms. The “ability of a system to perform work” is a common description, but it is difficult to give one single comprehensive definition of energy because of its many forms. For instance, in SI units, energy is measured in joules, and one joule is defined “mechanically”, being the energy transferred to an object by the mechanical work of moving it a distance of 1 meter against a force of 1 newton. However, there are many other definitions of energy, depending on the context, such as thermal energy, radiant energy, electromagnetic, nuclear, etc., where definitions are derived that are the most convenient.

Energy is generated for use by large populations using power plants having large generators, and quite often, a source of kinetic energy that can be converted into electrical energy is when available. For instance, hydroelectric dams use the moving water to turn turbines that in turn power generators that generate electricity. These are generally the most efficient forms of power generation since the water moves anyway and the hydroelectric plant just takes advantage of it. Many power plants use fossil fuels to power engines that turn generators to generate electrical energy. These types of power plants are the least effective in that the conversion factor from fossil fuel to electric energy is most often in the negative. Whatever power generating system is used, there is a conversion factor, or an efficiency factor, that determines the cost of production. The current methods for production, and the ways that electricity is generally used, is far from the most effective use of resources for the technology that is now available. An improvement is needed.

Various attempts have been made to solve the above-mentioned problems such as those found in U.S. Publication No. 2010/0006351 to J. Scott Howard; U.S. Pat. No. 6,082,476 to Nathan Stulbach; and U.S. Publication No. 2013/0062131 to Hencil Joel Cannon. None of the above inventions and patents, taken either singly or in combination, is seen to describe the invention as claimed.

Ideally, a power generating system should provide high efficiency, and yet, would operate reliably and be manufactured at a modest expense. Thus, a need exists for a reliable self-generating power generation system to avoid the above-mentioned problems.

### BRIEF SUMMARY OF THE INVENTION

In view of the foregoing disadvantages inherent in the known power generating systems art, the present invention provides a novel self-generating power generation system. The general purpose of the present invention, which will be described subsequently in greater detail, is to provide a high efficiency power generating system that self generates power off of the input power used to increase efficiency.

A self-generating power generation system comprising two batteries, a brushless DC motor, a generator, two gears with one of the two gears at least two times larger than the other one, two relays each having double switches, a regulator, and a diode. The two batteries, the motor, the generator, the gears, the relays, the regulator, and the diode are electrically connected together forming a power generation circuit.

A controller is included to control the power generation circuit between two modes based upon charge levels of the two batteries. The diode is adapted to ensure that electric power goes to the motor and not from the motor. One of the two batteries supplies power to the motor. The larger of the two gears is mechanically connected to the motor and also connected to the smaller gear to rotate it. The smaller gear is mechanically connected to the generator such that energy leaves the generator and is transferred to the regulator and is used to recharge the second battery.

There are two modes for the first relay. The first mode is a down mode wherein the regulator is connected to the relay. The controller is adapted to detect the second battery's voltage level and detect when it is full, and when full the second mode starts wherein electric current is reversed between the two batteries. The upper part of the second relay is connected to the motor such that the second battery is adapted to supply energy to the motor, and power is transferred to the first battery through the upper part of the first relay. The controller is adapted to detect the first battery's voltage level and detect when it is full, and when full the first mode starts, the electric current is reversed from the second mode between the two batteries.

A self-generating power generation system may comprise an automobile frame, a transmission that is mechanically connected to the automobile frame, at least two wheels mechanically connected to the automobile frame and the transmission, a motor mechanically connected to the automobile frame and the transmission, two batteries, a generator, two gears with one of the two gears at least two times larger than the other one, two relays each having double switches, a regulator, and a diode. The two batteries, the wheels, the motor, the generator, the gears, the relays, the regulator, and the diode are electrically connected together forming a power generation circuit.

A controller is included to control the power generation circuit between the two modes based upon charge levels of the two batteries. The diode is adapted to ensure that electric power goes to the motor and not from the motor. One of the two batteries supplies the motor with power. The larger gear is mechanically connected to the motor and is mechanically connected to the smaller gear to rotate it. The smaller gear is mechanically connected to the generator, such that energy leaves the generator and is transferred to the regulator and is used to recharge the second battery.

There are two modes for the first relay. The first mode is a down mode wherein the regulator is connected to the relay. The controller is adapted to detect the second battery's voltage level and detect when it is full, and when full the second mode starts wherein electric current is reversed between the two batteries. The upper part of the second relay is connected to the motor such that the second battery is adapted to supply energy to the motor and power is transferred to the first battery through the upper part of the first relay. The controller is adapted to detect the first battery's voltage level and detect when it is full, and when full the first mode starts wherein electric current is reversed from the second mode between the two batteries.

The present invention holds significant improvements and serves as a self-generating power generation system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, self-generating power generation system, constructed and operative according to the teachings of the present invention.

FIG. 1 shows a perspective view illustrating a self-generating power generation system according to an embodiment of the present invention.

FIG. 2 is a diagram illustrating a self-generating power generation system in a vehicle according to an embodiment of the present invention of FIG. 1.

FIG. 3 is a diagram illustrating self-generating power generation system according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a power generating system and more particularly to a self-generating power generation system as used to improve the efficiency of a power generating system by cogenerating power from the input power supply.

Generally speaking, a self-generating power generation system is a generating system that is designed to use a portion of the incoming power to generate additional power to make the system highly efficient. The system may be used in a motor vehicle and take advantage of the available kinetic energy of the turning wheels regenerate power to multiply the efficiency. The system uses two batteries, a brushless DC motor, a generator, gearing, relays, switches, a regulator, a diode, and a controller.

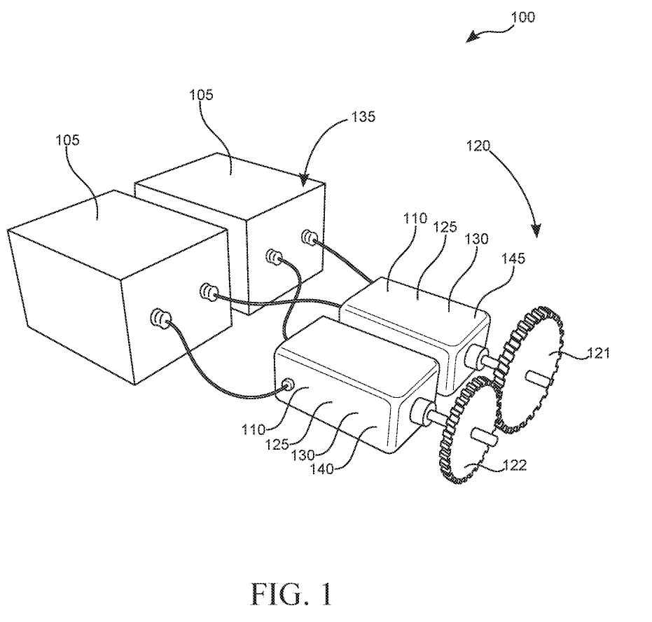

In greater detail now, referring to the drawings by numerals of reference there is shown in FIG. 1, a perspective view illustrating self-generating power generation system 100 according to an embodiment of the present invention.

Self-generating power generation system 100 is an efficient power system that uses a portion of the incoming operating power to generate additional power. The system preferably comprises two battery(s) 105, brushless dc motor 110, generator 115, two gears 120 with one of the two gears at least two times larger than the other one, two relay(s) 125 each having double switches 130, regulator 135, and diode 140. The two battery(s) 105, brushless dc motor 110, generator 115, gears 120 relay(s) 125, regulator 135, and diode 140 are electrically connected together forming power generation circuit 160. Controller 145 is included to control power generation circuit 160 between two modes based upon charge levels of the two battery(s) 105. Diode 140 is adapted to ensure that electric power goes to brushless dc motor 110 and not from brushless dc motor 110. One of the two battery(s) 105 supplies power to brushless dc motor 110. Larger gear 121 is mechanically connected to brushless dc motor 110 and also connected to smaller gear 122 to rotate it. Smaller gear 122 is mechanically connected to generator 115 such that energy leaves generator 115 and is transferred to regulator 135 and is used to recharge the second battery(s) 105. There are two modes for the first relay(s) 125. The first mode is a down mode wherein regulator 135 is connected to relay(s) 125. Controller 145 is adapted to detect the second battery(s) 105 voltage level and detect when it is full, and when full the second mode starts wherein electric current is reversed between the two battery(s) 105. The upper part of the second relay(s) 125 is connected to brushless dc motor 110 such that the second battery(s) 105 is adapted to supply energy to brushless dc motor 110, and power is transferred to the first battery(s) 105 through the upper part of the first relay(s) 125. Controller 145 is adapted to detect the first battery(s) 105 voltage level and detect when it is full, and when full the first mode starts, the electric current is reversed from the second mode between the two battery(s) 105.

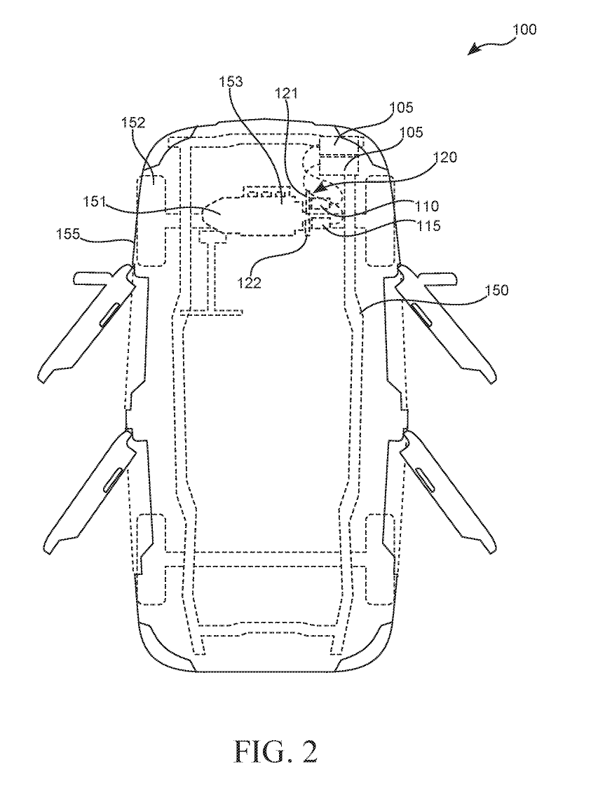

Referring now to FIG. 2, is a diagram illustrating self-generating power generation system 100 in vehicle 155 according to an embodiment of the present invention of FIG. 1.

Self-generating power generation system 100 may be used in conjunction with vehicle 155 comprising automobile frame 150, transmission 151 that is mechanically connected to automobile frame 150, at least two wheels 152 mechanically connected to automobile frame 150 and transmission 151, motor 153 mechanically connected to automobile frame 150 and transmission 151, two battery(s) 105, generator 115, two gears 120 with one of the two gear(s) 120 at least two times larger than the other gear(s) 120, two relay(s) 125 each having double switches 130, regulator 135, and diode 140. The two battery(s) 105, wheels 152, motor 153, generator 115, gear(s) 120, relay(s) 125, regulator 135, and diode 140 are electrically connected together forming power generation circuit 160. Controller 145 is included to control power generation circuit 160 between the two modes based upon charge levels of the two battery(s) 105. Diode 140 is adapted to ensure that electric power goes to brushless dc motor 110 and not from brushless dc motor 110. One of the two battery(s) 105 supplies brushless dc motor 110 with power. Larger gear 121 is mechanically connected to brushless dc motor 110 and is mechanically connected to smaller gear 122 to rotate it. Smaller gear 122 is mechanically connected to generator 115, such that energy leaves generator 115 and is transferred to regulator 135 and is used to recharge the second battery(s) 105.

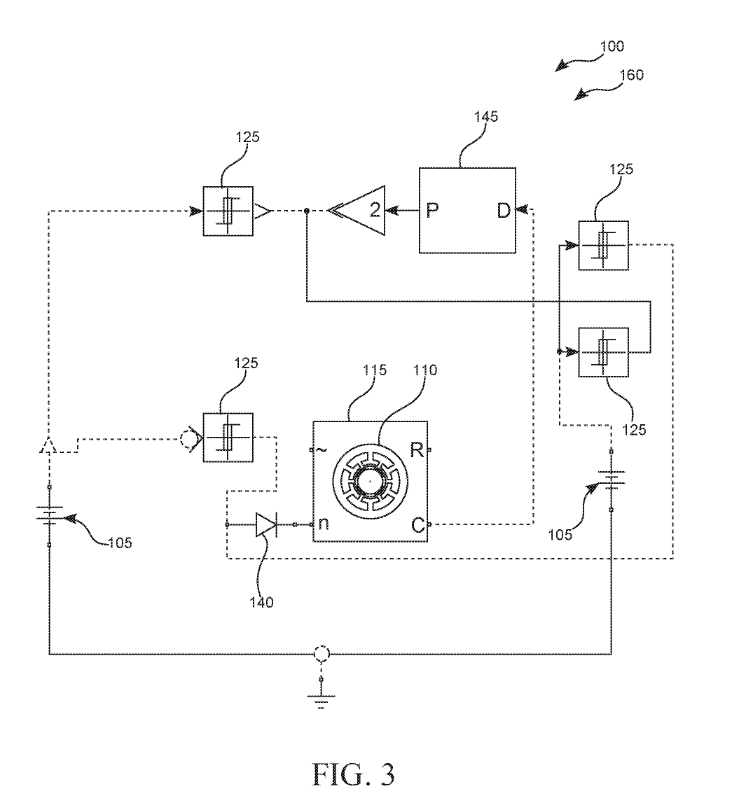

Referring now to FIG. 3, is a diagram illustrating self-generating power generation system 100 according to an embodiment of the present invention of FIG. 1.

There are two modes for the first relay(s) 125. The first mode is a down mode wherein the regulator is connected to relay(s) 125. Controller 145 is adapted to detect the second battery(s) 105 voltage level and detect when it is full, and when full the second mode starts wherein electric current is reversed between the two battery(s) 105. The upper part of the second relay(s) 125 is connected to brushless DC motor 110 such that the second battery(s) 105 is adapted to supply energy to brushless DC motor 110 and power is transferred to the first battery(s) 105 through the upper part of the first relay(s) 125. Controller 145 is adapted to detect the first battery(s) 105 voltage level and detect when it is full, and when full the first mode starts wherein electric current is reversed from the second mode between the two battery(s) 105.

Upon reading this specification, it should be appreciated that, under appropriate circumstances, considering such issues as design preference, user preferences, marketing preferences, cost, structural requirements, available materials, technological advances, etc., other components or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A self-generating power generation system comprising:
two batteries;
a brushless DC motor;
a generator;
two gears;
wherein one of said two gears is at least two times larger than the other one of said two gears;
two relays;
wherein each of said two relays includes double switches;
a regulator;
a diode;
wherein said two batteries, said motor, said generator, said gears, said relays said regulator, and said diode are electrically connected together forming an power generation circuit; and
a controller;
wherein said controller controls said power generation circuit between two modes based upon charge levels of said two batteries.

2. The self-generating power generation system of claim 1, wherein said diode is adapted to ensure that electric power goes to said motor and not from said motor.

3. The self-generating power generation system of claim 1, wherein one of said two batteries is supplying said motor with power; said larger gear is mechanically connected to said motor; said larger gear is mechanically connected to the smaller gear to rotate it; said smaller gear is mechanically connected to said generator, such that energy leaves said generator and is transferred to said regulator and is used to recharge the second battery.

4. The self-generating power generation system of claim 3, wherein there are two modes for the first relay; wherein the first mode is a down mode wherein said regulator is connected to said relay.

5. The self-generating power generation system of claim 4, wherein said controller is adapted to detect the second battery's voltage level and detect when it is full, and when full said second mode starts, wherein electric current is reversed between said two batteries.

6. The self-generating power generation system of claim 5, wherein an upper part of said second relay is connected to said motor, such that said second battery is adapted to supply energy to said motor and power is transferred to said first battery through an upper part of said first relay.

7. The self-generating power generation system of claim 6, wherein said controller is adapted to detect the first battery's voltage level and detect when it is full, and when full said first mode starts, wherein electric current is reversed from said second mode between said two batteries.

8. A self-generating power generation system comprising:
an automobile frame;
a transmission;
wherein said transmission is mechanically connected to said automobile frame;
at least two wheels;
wherein said at least two wheels are mechanically connected to said automobile frame and said transmission;
a motor;
wherein said motor is mechanically connected to said automobile frame and said transmission;
two batteries;
a generator;
two gears;
wherein one of said two gears is at least two times larger than the other one of said two gears;
two relays;
wherein each of said two relays includes double switches;
a regulator;
a diode;
wherein said two batteries, said at least two wheels, said motor, said generator, said gears, said relays said regulator, and said diode are electrically connected together forming an power generation circuit; and
a controller;
wherein said controller controls said power generation circuit between two modes based upon charge levels of said two batteries.

9. The self-generating power generation system of claim 8, wherein said diode is adapted to ensure that electric power goes to said motor and not from said motor.

10. The self-generating power generation system of claim 8, wherein one of said two batteries is supplying said motor with power; said larger gear is mechanically connected to said motor; said larger gear is mechanically connected to the smaller gear to rotate it; said smaller gear is mechanically connected to said generator, such that energy leaves said generator and is transferred to said regulator and is used to recharge the second battery.

11. The self-generating power generation system of claim 10, wherein there are two modes for the first relay; wherein the first mode is a down mode wherein said regulator is connected to said relay.

12. The self-generating power generation system of claim 11, wherein said controller is adapted to detect the second battery's voltage level and detect when it is full, and when full said second mode starts, wherein electric current is reversed between said two batteries.

13. The self-generating power generation system of claim 12, wherein an upper part of said second relay is connected to said motor, such that said second battery is adapted to supply energy to said motor and power is transferred to said first battery through an upper part of said first relay.

14. The self-generating power generation system of claim 13, wherein said controller is adapted to detect the first battery's voltage level and detect when it is full, and when full said first mode starts, wherein electric current is reversed from said second mode between said two batteries.
